(19) United States
(12) Patent Application Publication
(10) Pub. No.: US 2023/0112901 A1
(43) Pub. Date: Apr. 13, 2023

(54) METHOD FOR LOADING AND REPLACING TOOLS IN MACHINING CENTERS PROVIDED WITH A MECHANIZED TOOL MAGAZINE, AND MACHINING CENTER USING THE METHOD

(71) Applicant: VIGEL S.P.A., Borgaro Torinese (IT)

(72) Inventor: Daniele FRANCESIA VILLA, Mezzenile (IT)

(73) Assignee: VIGEL S.P.A., Borgaro Torinese (IT)

(21) Appl. No.: 16/606,468

(22) PCT Filed: Apr. 11, 2018
(86) PCT No.: PCT/EP2018/059314

§ 371 Date: Oct. 18, 2019

(30) Foreign Application Priority Data
Apr. 19, 2017 (IT) 102017000042590

(51) Int. Cl. B23Q 3/155; B23Q 3/157

(52) U.S. Cl. CPC B23Q 3/15533; B23Q 3/1554; B23Q 3/15786

(57) ABSTRACT

In a machining center provided with a mechanized tool magazine and with at least one movable tool-holding spindle capable of accessing the tool magazine, the tool is picked up from the tool-holding spindle and transferred to a tool replacement area by means of a dedicated, automatic transfer device that is independent of the tool magazine. After the replacement of the tool with a new tool in the transfer device, the new tool is returned to the tool-holding spindle by means of the transfer device.

The present invention relates to a method for loading and replacing tools in machining centers provided with a mechanized tool magazine and to a machining center that uses said method.

As is known, a generic machining center can generally comprise multiple motorized tool-holding spindles, for example two, three or four spindles, which are mounted on a machining head with the respective axes arranged horizontally or vertically and parallel to each other. The spindles can move along two or more axes in relation to respective parts to be machined, so as to subject simultaneously multiple parts to various successive machinings, for example milling, boring, tapping, and the like.

The parts to be machined can be fixed on a motorized part holding drum arranged at eye level in front of the spindles, with its axis horizontal and perpendicular to the axis of the spindles. The part holding drum supports typically two series of parts in diametrically opposite positions, and rotates in steps of 180° so as to alternately move one of the two series of parts in front of the spindles to be machined and the other series in a safe external region on the front side of the machine, so as to allow the operator to replace the parts that have already been machined with the unfinished ones.

In order to maximize productivity, machining centers of the type described above are usually provided with a mechanized tool magazine, from which the spindles automatically pick up the tools to be used in the various machining steps, utilizing the mobility in space of the machining head.

One type of known magazine, which is particularly appreciated for its reliability, is composed of a motorized tool holding drum. In the case of machining centers with spindles having a horizontal axis, the tool holding drum is also arranged in front of the spindles above the part holding drum, with its axis horizontal and perpendicular to the axis of the spindles but in a more inward position with respect to the perimeter of the machine.

The loading of the tools, as well as the periodic replacement of the worn tools, are performed manually. For this purpose, currently the operator must climb up a ladder which is provided on the front side of the machine and lean up to the tool holding drum.

This operation can be awkward and sometimes even risky, especially in larger machining centers in which the tool holding drum is arranged in a greatly recessed position with respect to the front of the machine; this also in view of the weight of the tools, which in certain cases can exceed 10 kg.

Generally speaking, it can be said that the larger the machining center, the more it is difficult to replace the tools; to the point that for larger machining centers it would be necessary to prepare extremely bulky and expensive structures in order to allow the user to access frontally the tool holding drum in order to replace the worn tools.

A further drawback of the above cited system occurs in the frequent case in which the operations for loading/unloading the parts are performed automatically by a single robot that serves multiple machines simultaneously. In fact, like the operator who loads/replaces the tools, the robot that loads/unloads the parts also must access the front side of the machine. Accordingly, for safety reasons, while the operator is working the robot must be halted, thus halting production not only of the machine involved but also potentially of all the other machines that face each other and are served by the same robot.

Therefore, the aim of the present invention is to provide a method for loading and replacing tools in machining centers provided with a mechanized tool magazine, and a machining center which uses this method, which render the tool replacement operations faster, easier, more ergonomic and safer.

This aim and these and other objects which will become better apparent hereinafter are achieved by the method having the characteristics described in claim 1 and by the machining center having the characteristics described in claim 7, while the dependent claims define other advantageous characteristics of the invention, albeit secondary ones.

The invention is now described in greater detail with reference to some preferred but not exclusive embodiments thereof, illustrated by way of nonlimiting example in the accompanying drawings, wherein:

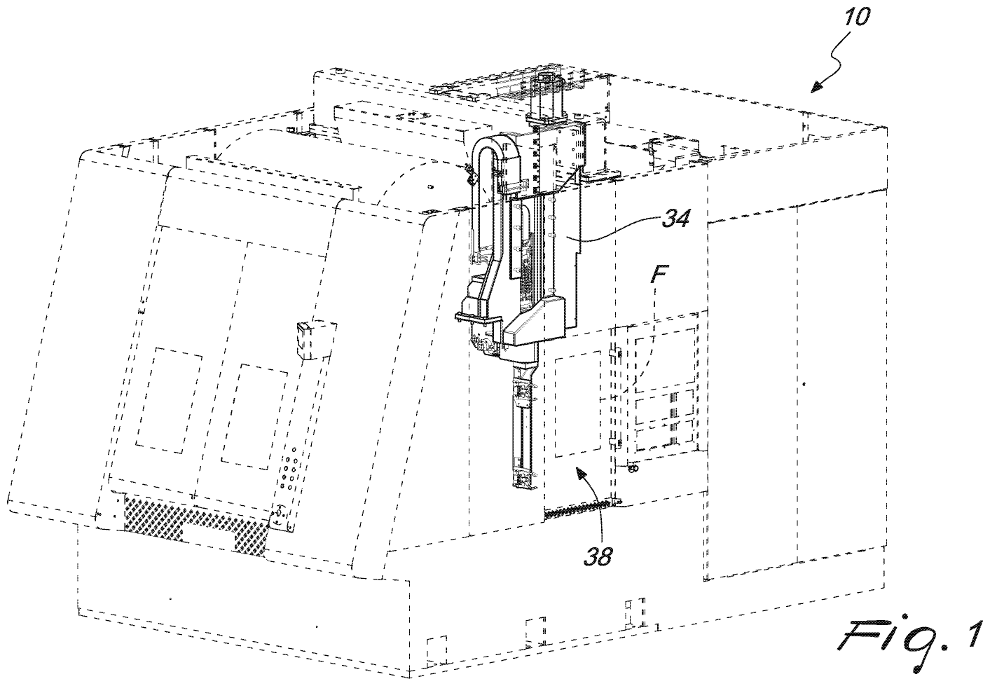

FIG. 1 is a perspective view of a machining center to which the method according to the invention is applied;

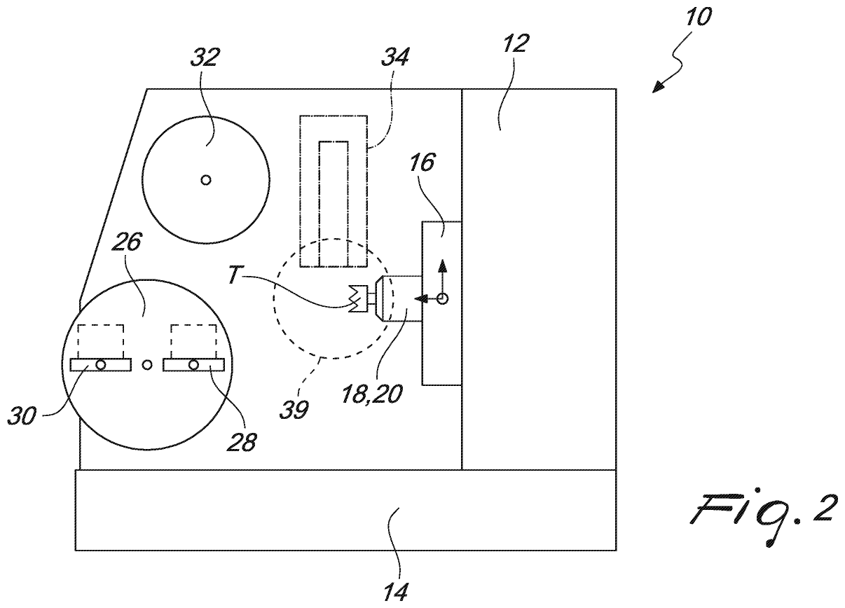

FIG. 2 is a schematic lateral elevation view of the machining center of FIG. 1;

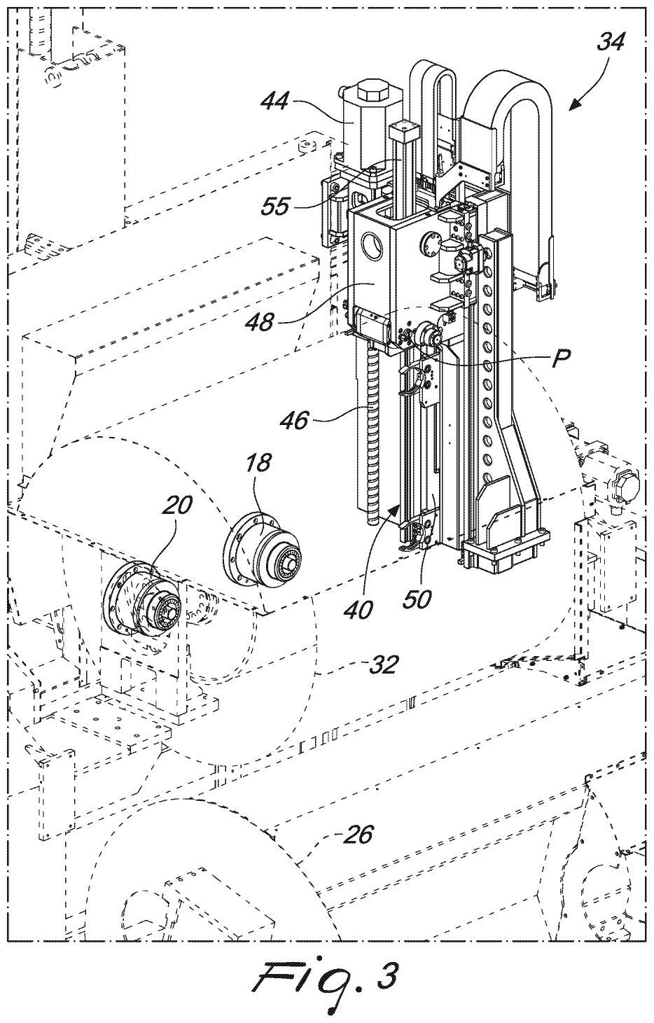

FIG. 3 is a perspective view of a portion of the machining center of FIG. 1 in a first step of operation;

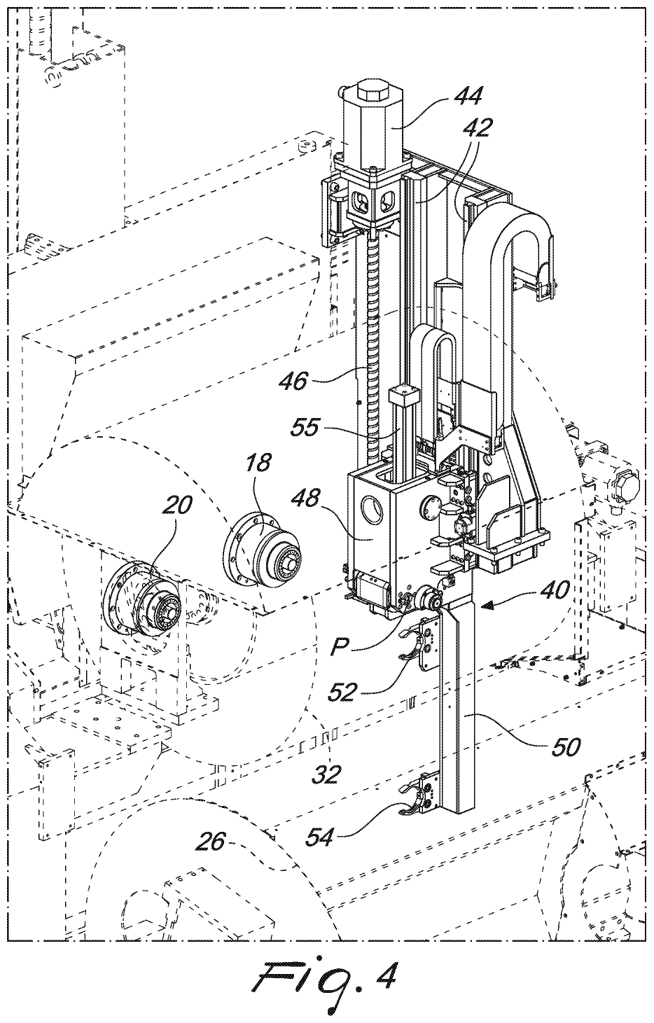

FIG. 4 is a perspective view of a portion of the machining center of FIG. 1 in a second step of operation;

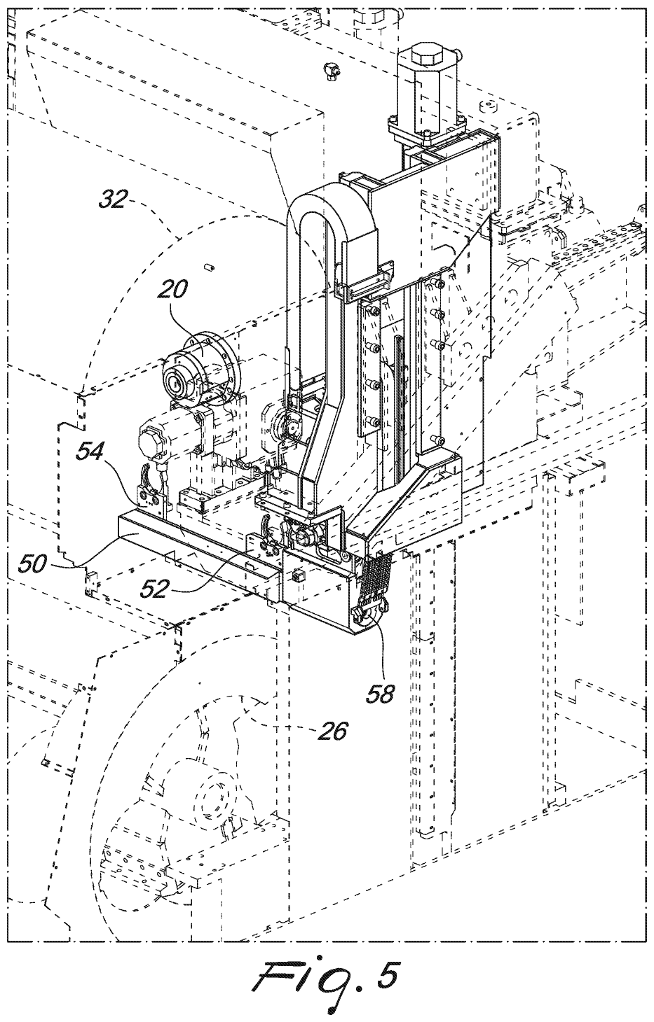

FIG. 5 is a perspective view of a portion of the machining center of FIG. 1 in a fifth step of operation;

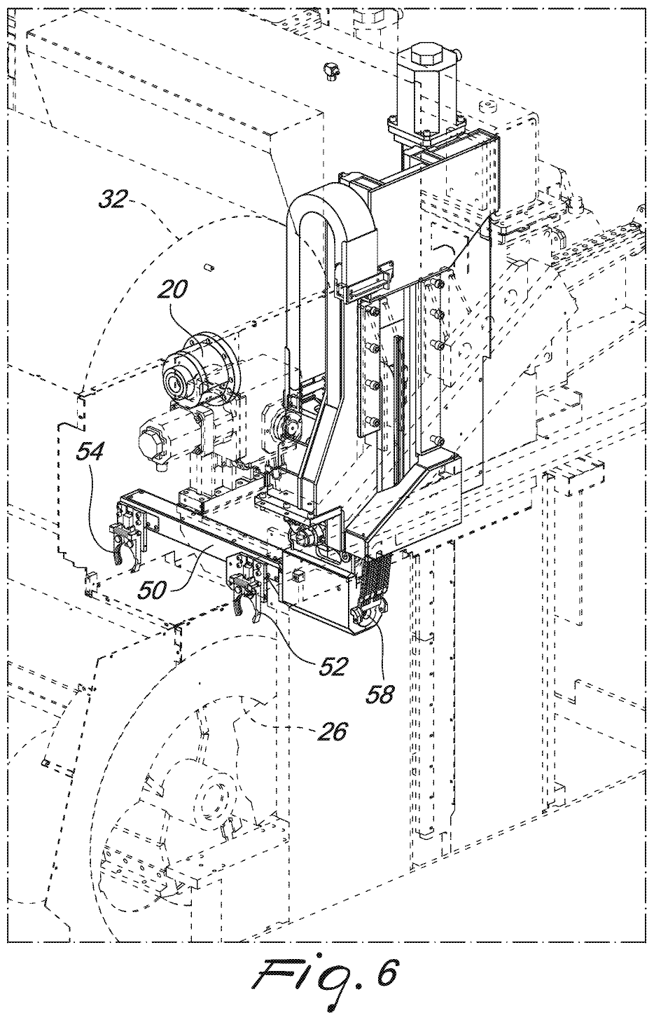

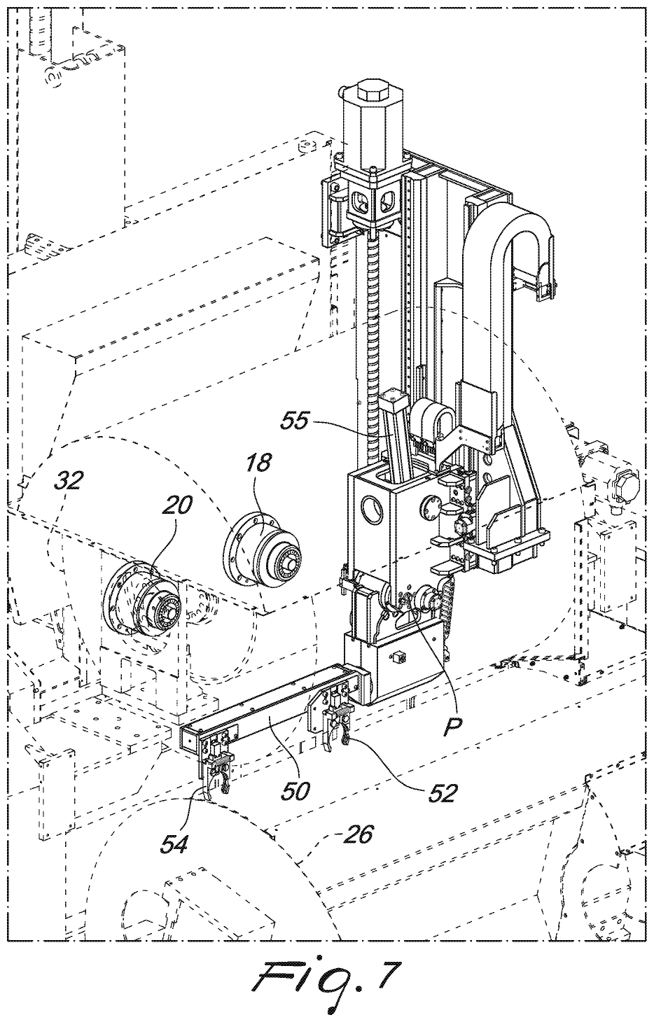

FIGS. 6 and 7 are two perspective views of a portion of the machining center of FIG. 1 in a third step of operation, from two different angles;

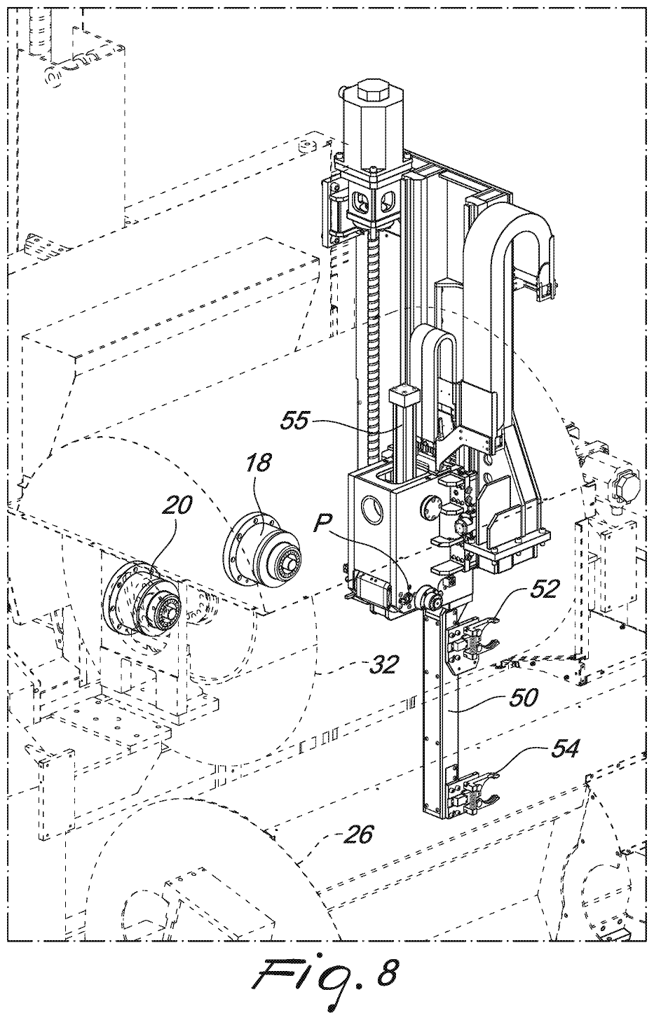

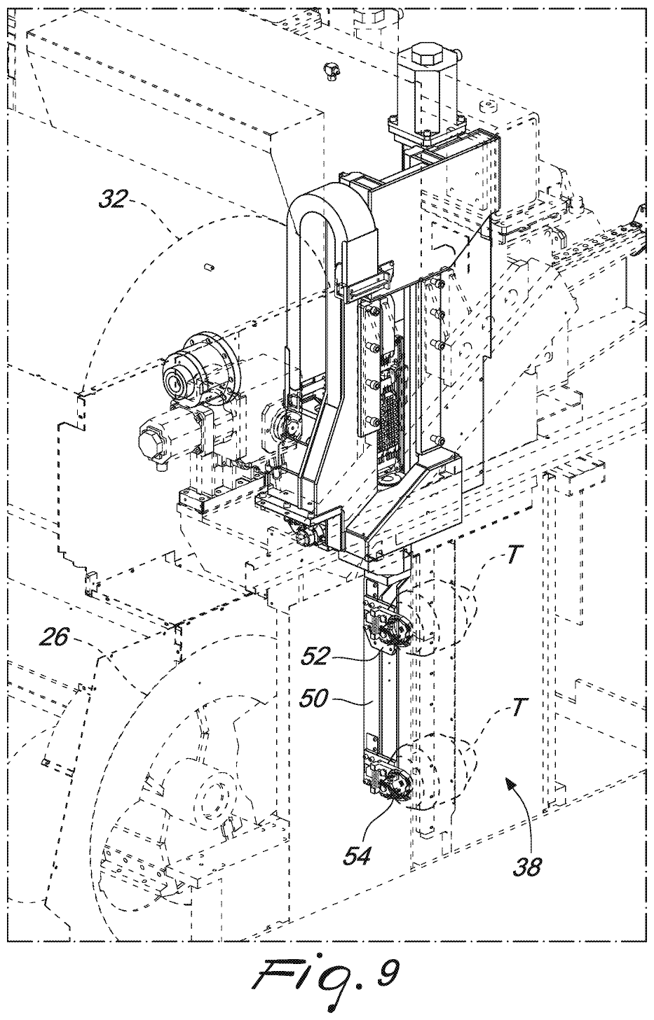

FIGS. 8 and 9 are two perspective views of a portion of the machining center of FIG. 1 in a fourth step of operation, from two different angles.

With initial reference to FIGS. 1 and 2, a machining center 10 comprises a structure 12 supported by a footing 14.

The frame 12 supports a per se known machining head 16. In the example described here, the machining head 16 supports two motorized tool-holding spindles 18, 20, which are arranged with their respective axes horizontal and mutually parallel. In a per se conventional manner, the machining head 16 can move in the directions of the three Cartesian axes under the control of actuation means (not shown).

The parts to be machined are mounted on a motorized part holding drum 26, which is arranged at eye level in front of the spindles 18, 20 with its axis horizontal and parallel to the axis of the spindles 18, 20. The part holding drum 26 supports two part holding cross-members 28, 30 in diametrically opposite positions, and rotates in steps of 180° so to move alternately one of the two part holding cross-members (28 in FIG. 2) in front of the spindles 18, 20 for machining, and the other one (30 in FIG. 2) in a safe external region in the front part of the machine. This allows an operator (not shown) to replace the parts that have already been machined with the unfinished ones while the machine is in operation.

The machining center 10 is furthermore provided with a mechanized tool magazine, from which the spindles 18, 20 pick up automatically the tools to be used in the various machining steps.

In the embodiment described here, the tool magazine comprises a motorized tool holding drum 32 which is per se conventional and is also arranged in front of the spindles 18, 20 above the part holding drum 26. The tool holding drum 32 has its axis horizontal and parallel to the axis of the spindles, but is arranged in a further inward position with respect to the part holding drum 26.

The various machinings, as well as the tool changing operations, are managed by a control unit (not shown) in a fully automated manner.

According to the invention, for the loading and periodic replacement of the tools, the operator does not access directly the tool holding drum 32 as the machining center 10 is provided with a dedicated automatic transfer device 34, which is independent of the tool magazine 32 and is controlled by the control unit to pick up the worn tools from the spindles 18, 20 and transfer them to a tool loading/replacement area 38 which can be easily accessed by the user (FIG. 1), and vice versa for storing the new tools.

In practice, for the replacement of the worn tools, the spindles 18, 20 pick up the worn tools T from the tool holding drum 32 and preferably move them to a preset tool pickup area 39 (FIG. 2), which can be accessed by the transfer device 34. Then the transfer device 34 simultaneously moves both worn tools into the tool replacement area 38, which in the embodiment described here is advantageously arranged at eye level on a free side of the machine (FIG. 1). Once the operator has manually replaced the worn tools with the new ones, the transfer device 34 returns the new tools to the spindles 18, 20, which store them in the tool holding drum 32 or use them, depending on the work cycle.

Of course, if at the time of replacement the tools to be replaced are already mounted on the spindles 18, 20, the transfer device 34 will pick up the tools from the spindles directly.

However, obviously for the loading of the tool holding drum 32 only some of the steps listed above are necessary.

With particular reference now to FIGS. 3-9, in the embodiment described here the transfer device 34 comprises an articulated arm 40 which can move along vertical guides 42 between a raised resting position (FIG. 3) and a lowered working position (FIGS. 4-9), under the control of a motor 44 with a ballscrew transmission 46 interposed.

The articulated arm 40 is provided with an upper proximal portion 48 which is coupled slidingly to the vertical guides 42 and with a lower distal portion 50 which is pivoted to the proximal portion 48 about a pivot P which is parallel to the axis of the spindles 18, 20. The distal portion 50 supports a pair of tool holding clamps 52, 54 at its opposite ends, which are mutually spaced in a manner that corresponds to the spindles 18, 20.

In an alternative embodiment (not shown), the distal portion 50 might be provided so that it is telescopic, with the distance between the clamps that therefore can vary, for example in order to facilitate the loading of the tools on the part of the operator.

The distal portion 50 can rotate through 90° about the pivot P, under the control of first actuation means 55, between a first position which is extended vertically downward (FIGS. 3, 4, 8 and 9), in which the tool holding clamps 52, 54 engage the tool replacement area 38, and a second horizontal position (FIGS. 5-7), in which the tool holding clamps 52, 54 coaxially face the spindles 18, 20. Advantageously, the first actuation means comprise a hydraulic actuator, but as an alternative one might provide electromechanical or pneumatic solutions and the like.

The distal portion 50 can also rotate through 180° about its own axis, under the control of second actuation means 58 (FIGS. 5 and 6), between a position for interfacing with the spindles (FIGS. 3-5), in which the tool holding clamps 52, 54 are directed inward with respect to the joint and support the tools T with the respective shanks directed toward the spindles 18, 20, and a position for interfacing with the user (FIGS. 6-9), in which the tool holding clamps 52, 54 are easily accessible to the user when the articulated arm 40 is in the tool replacement position 38.

Advantageously, the position for interfacing with the user is rotated substantially through 180° with respect to the position for interfacing with the spindles, with the tool holding clamps 52, 54 directed outward with respect to the joint, and support the tools with the respective shanks directed oppositely with respect to the spindles 18, 20. In this case also, the second actuation means 58 advantageously comprise a hydraulic actuator, but as an alternative one might provide electromechanical or pneumatic solutions and the like.

Furthermore, the transfer device 34 is advantageously provided with a read/write device (not shown) for each of the tool holding clamps 52, 54, which is adapted to interface with a chip (not shown) on the tool in order to read, write and/or save data related to geometry, wear, and the like, for process monitoring purposes.

In operation, the articulated arm 40 performs the movements described hereinafter.

The spindles 18, 20 pick up the tools to be replaced from the tool holding drum 32 and move them to the tool pickup area 39. In the meantime, the articulated arm 40 descends from the raised resting position of FIG. 3 to the lowered working position of FIG. 4. Then the distal portion 50 of the articulated arm 40 rotates through 90° in the horizontal position of FIG. 5 in order to pick up the tools from the spindles 18, 20.

Once the tools have been picked up by the spindles, the distal portion rotates through 180° about its own horizontal axis, as shown in FIGS. 6 and 7. At this point the distal portion 50 returns to the vertical position of FIGS. 8 and 9 so as to move the tools T in the tool replacement area 38 on the free side of the machine; as shown in FIG. 9, the tools T are directed outward so that they can be easily handled by the user.

Once the user has replaced the tools manually, the articulated arm 40 performs the movements described above in reverse order in order to return the new tools to the spindles.

As the person skilled in the art can appreciate, the described method and machining center fully achieve the intended aim and objects, since they render the tool replacement operations faster, easier, more ergonomic and safer for the user.

In particular, the user, instead of picking up/storing the tools directly from/in the tool magazine, which is arranged in an awkward position which is difficult to access, performs these operations in a convenient position without affecting the front part of the machine. In this manner, any robot assigned to the unloading/loading of the parts can continue to operate without risks.

A preferred embodiment of the invention has been described, but of course the person skilled in the art may apply different modifications and variations within the scope of the appended claims.

For example, although in the embodiment described herein the magazine is of the drum type, the invention is of course applicable also to machining centers provided with magazines of a different type, such as chain magazines or disk magazines. In the case of chain magazines, for example, the invention might be useful to create a path of the chain that is less convoluted or capable of increasing the tool storage capacity.

Furthermore, in the example described herein, the articulated arm 40 must perform three movements (rise/descent of the proximal portion 48; bending through 90°; rotation through 180° of the distal portion 50) in order to adapt to the layout and to the space occupation of the machine. In particular, the rise to the resting position is necessary so that the work area is visible from a side window F during machining operations (FIG. 1), the opposite side of the machine being engaged by other equipment. However, depending on the type of machine, one or more of the movements of the arm might be eliminated. For example, if the work area is visible from a window on the opposite side, the rise to the resting position will not be necessary. Nevertheless, again depending on the layout and the space occupations of the machine, the articulated arm 40 might slide horizontally or obliquely between the resting position and the active position, instead of vertically.

The disclosures in Italian Patent Application No. 102017000042590 from which this application claims priority are incorporated herein by reference.

1-13. (canceled)

14. A method for loading and replacing tools in machining centers provided with a mechanized tool magazine and with at least one movable tool-holding spindle, which is capable of accessing said tool magazine, comprising the steps of:
picking up the tool from said at least one tool-holding spindle and transferring the tool to a tool replacement area by means of a dedicated, automatic transfer device that is independent of said tool magazine, and
after the replacement of the tool with a new tool in the transfer device, returning the new tool to said at least one tool-holding spindle by means of said automatic transfer device.

15. The method according to claim 14, wherein said machining center also comprises at least two of said tool-holding spindles which are supported by a machining head that can move along at least one axis, wherein said automatic transfer device picks up from, and returns to, said at least two tool-holding spindles the respective tools simultaneously.

16. The method according to claim 14, wherein said automatic transfer device, at rest, is parked in a resting position such that it does not engage said tool replacement area.

17. The method according to claim 14, wherein as a first step and as a final step said tool-holding spindle respectively picks up and returns the tools from/to said tool magazine.

18. The method according to claim 14, wherein said transfer device picks up from, and returns to, said at least one tool-holding spindle a respective tool in a preset pickup/return position.

19. The method according to claim 14, wherein the movements of said transfer device are controlled in an automated manner by a control unit.

20. A machining center provided with a mechanized tool magazine and with at least one movable tool-holding spindle capable of accessing said tool magazine, comprising a dedicated, automatic transfer device that is independent of said tool magazine, which is controlled to pick up a tool from said at least one tool-holding spindle and transfer the tool to a tool replacement area and, after replacement of the tool in the transfer device, returning the new tool to said at least one tool- holding spindle.

21. The machining center according to claim 20, comprising at least two of said tool-holding spindles which are supported by a machining head that can move along at least one axis, wherein said transfer device is provided with tool-gripping means which can be mutually spaced in a manner that corresponds to said at least two tool-holding spindles in order to pick up and return the respective tools simultaneously.

22. The machining center according to claim 20, wherein said automatic transfer device comprises an articulated arm which has a distal portion which is adapted to rotate, under the control of first actuation means, between a first position, in which said tool-gripping means engage said tool replacement area, and a second position, in which said tool-gripping means face said spindles.

23. The machining center according to claim 22, wherein said distal portion is pivoted to a proximal portion that can move between a resting position and a working position under the control of second motor means.

24. The machining center according to claim 23, wherein said resting position and said working position are vertically spaced.

25. The machining center according to claim 23, wherein said distal portion is connected so that it can rotate about its own axis to said proximal portion in order to rotate, under the control of further actuation means, between a position for interfacing with the spindles, in which said tool-gripping means support the tools with the respective shanks directed toward said tool-holding spindles, and a position for interfacing with the user, in which said tool-gripping means can be easily accessed by the user when said articulated arm is in said tool replacement area.

26. The machining center according to claim 20, wherein said automatic transfer device is provided with a read/write device which is adapted to interface with a chip on the tool in order to read, write and/or save data related to geometry, wear, and the like.
